(19) United States
(12) Patent Application Publication
(10) Pub. No.: US 2015/0161877 A1
(43) Pub. Date: Jun. 11, 2015

(54) Systems And Methods For Event-Based Reporting and Surveillance and Publishing Event Information

(71) Applicants: Jari HÄMÄLÄINEN, Kangasala As (FI); Ismail MOHAMUD, Flower Mound, TX (US); Saswat MISRA, New York, NY (US)

(72) Inventors: Jari HÄMÄLÄINEN, Kangasala As (FI); Ismail MOHAMUD, Flower Mound, TX (US); Saswat MISRA, New York, NY (US)

(73) Assignee: VRINGO LABS LLC

(21) Appl. No.: 14/535,072

(22) Filed: Nov. 6, 2014

Related U.S. Application Data
(60) Provisional application No. 61/900,881, filed on Nov. 6, 2013.
(60) Provisional application No. 61/900,905, filed on Nov. 6, 2013.
(60) Provisional application No. 61/903,197, filed on Nov. 12, 2013.
(60) Provisional application No. 61/903,159, filed on Nov. 12, 2013.

(51) Int. Cl. G08B 25/01; H04N 5/91; H04N 1/21; H04L 12/58; G08B 13/196; G08B 25/08; H04L 29/08; H04N 5/232; H04N 21/2743

(52) U.S. Cl. CPC G08B 25/016; H04N 5/23206; H04N 5/91; H04N 1/2112; H04N 21/2743; G08B 13/19658; G08B 13/19665; G08B 13/19621; G08B 25/08; H04L 67/10; H04L 51/10

(57) ABSTRACT

Disclosed herein are techniques for collecting information related to a crime or distress scene. An indication is received that a phone (“distressed phone”) has declared an emergency or distress event and a location of the distressed phone is also received. An additional set of phones, and their associated geographic locations, in vicinity of the distressed phone at a time that the distressed phone declared the emergency or distress event is determined. For each of the additional set of phones and the distressed phone, a number of cameras capable of tracking that phone is determined. For a phone from the additional set of phones and the distressed phone, video or image data related to a user of the phone is captured using at least one of the determined number of cameras capable of tracking that phone.

### RELATED APPLICATIONS

This application claims priority from U.S. Provisional Patent Application Ser. No. 61/900,881 filed on Nov. 6, 2013; Ser. No. 61/900,905 filed on Nov. 6, 2013; Ser. No. 61/903,159 filed on Nov. 12, 2013; and Ser. No. 61/903,197 filed on Nov. 12, 2013.

### 1. FIELD OF THE INVENTION

The present disclosure relates to techniques for performing event-based video and image reporting in the context of, inter alia, emergency and distress response scenarios, user-assisted publishing of event information to social media or a personal distribution list, and predictive offline data downloading on wireless communication devices.

### BACKGROUND

Modern day users want to stay connected to the internet all the time so that they may be able to remain connected with friends and family while on the move. Social networking and social media applications including free chat applications, free internet calling, emails, and a diversity of messaging services available today have made that possible. Users need to access fast and cost efficient wireless broadband network locally and while travelling away from home location. However, the primary requirement for using any of these services is connectivity to the Internet. Most communication devices are equipped with features that enable them to connect to internet using a plurality of technologies including but not limited to Wi-Fi, GPRS, WLAN, and the like.

Wi-Fi connectivity is especially preferred by users in situations where using the traditional cellular network may not be preferable for communications, such as while roaming abroad, where traditional cellular networks may be very expensive. In such a situation, there may be plenty of Wi-Fi networks available, but the user may not be aware of the location at which they may access a Wi-Fi hotspot. Even if the location of the Wi-Fi hotspot is known, still the user may not be aware of the authentication information, such as a security key that may be required for establishing connection through that Wi-Fi network. This may happen because most of these networks may be secure and their usage may require payment of a fee to a service provider of the network. Alternatively, there may be situations when the user is not able to find any available hotspot.

Modern mobile devices, including smartphones, tablets, portable digital assistants (PDAs) and other devices, provide functionality to capture video and images and provide the captured video and images to a remote destination via a network connection (e.g., a cellular, WiFi, RFID, or Bluetooth connection.

There are several existing techniques for capturing information on the behavior of persons at or near a crime or distress scene. These techniques rely mostly on capturing image or video data from a camera that initiated a 911 or emergency call. See, e.g., United States Patent App. Pub. No. 2011/0319051. A first drawback to these techniques is that they fail to capture the behavior of suspected persons who immediately or gradually flee the scene (e.g., a fleeing assailant). A second drawback to these techniques is that they rely on footage shot from the vantage point of a camera of a participant or bystander located in the middle of the crime or distress scene. Such a camera is often not at the best vantage point to record scene details. Accordingly, it would be desirable to provide techniques for automatically recording behaviors of those present at the origin of a crime or distress scene as they move away from the scene and from useful vantage points.

There are several existing techniques for documenting evidence at the scene of a vehicle accident using video and still images. Most of these techniques involve active human involvement, e.g., a human accident scene photographer. A small number of automated techniques in existence typically involve use of a camera on a vehicle that is itself involved in the accident. However, there are drawbacks to these automated approaches. First, a camera on a car that has been in an accident may malfunction. Second, such a camera is often not at the best vantage point to record accident scene evidence (indeed, even if the camera is well-positioned, no single camera typically provides a compressive account of an accident scene). Accordingly, it would be desirable to provide techniques for automatically recording information at an accident scene without human involvement and using multiple cameras and/or camera(s) located at positions other than that of a vehicle involved in an accident. (The term “accident” as used herein is broad and may include events from minor “fender benders” to those involving major structural damage to a vehicle.)

Individuals currently inform friends, acquaintances, and others in their social network of events they have visited by manually selecting pictures and/or video that they themselves captured on a personal device (e.g., phone or camera). This approach requires that the individual interrupt his or her enjoyment of the event to take the pictures and/or video. Further, if the individual takes many pictures and/or a large number of videos, this approach requires the individual to spend a significant amount of time reviewing the media to determine which pictures and/or video the individual wants to provide to his or her social network. Another disadvantage of the current approach is that, even if the individual is enthusiastic about reviewing media, the individual may not be in the best position to capture representative pictures and/or video of the event. For example, aerial shots may provide the most representative and informative views of a large demonstration being staged on the National Lawn in Washington, DC. However, it may be difficult or impossible for an individual demonstrator to capture a picture that conveys an appropriate sense of grandeur of the event from his or her ground-level perspective.

### SUMMARY

What is required is a fast, intuitive and cost efficient connectivity solution that is global in scope and that may be able to provide internet access to users, such as through a Wi-Fi hotspot, irrespective of the user's location and network authorization requirements.

A method and system for determining user data is disclosed. Information related to a user is retrieved from device event data. A future data requirement of the user is predicted based on the device event data. Data for offline downloading is identified based on the predicted future data requirement. The identified data is downloaded.

Presented herein are techniques for performing event-based video and image reporting in the context of, inter alia, emergency and distress response scenarios. More detail, disclosed herein are techniques for collecting information related to a crime or distress scene. An indication is received that a phone (“distressed phone”) has declared an emergency or distress event and a location of the distressed phone is also received. An additional set of phones, and their associated geographic locations, in vicinity of the distressed phone at a time that the distressed phone declared the emergency or distress event is determined. For each of the additional set of phones and the distressed phone, a number of cameras capable of tracking that phone is determined. For a phone from the additional set of phones and the distressed phone, video or image data related to a user of the phone is captured using at least one of the determined number of cameras capable of tracking that phone.

Presented herein are techniques for performing event-based video and image surveillance related to, inter alia, vehicular accidents. In more detail, disclosed herein are techniques for reporting accident scene information. An indication that an accident occurred at a location is received. A database is searched to identify one or more addressable cameras located in vicinity of the location. The identified one or more addressable cameras are instructed to record video or image data of an accident scene in vicinity of the location. The recorded video or image data is provided to an authority.

Presented herein are techniques for the user-assisted publishing of event information to social media or a personal distribution list. In more detail, presented herein are techniques for generating a video or photo stream. An event that a user visited or participated in is determined. Video or image data depicting aspects of the event is identified. The identified video or image data is presented to the user. The user's selection of at least some of the identified video or image data is received. The user's selection of at least some of the identified video or image data is associated with at least one of a social media website and an e-mail distribution list.

### BRIEF DESCRIPTION OF DRAWINGS

Aspects and features of the presently-disclosed systems and methods will become apparent to those of ordinary skill in the art when descriptions thereof are read with reference to the accompanying drawings, of which:

FIG. 1 depicts an illustrative process for capturing information on persons in the vicinity of a crime or distress scene in accordance with an embodiment.

FIG. 2 depicts an illustrative process for capturing vehicular accident scene information in accordance with an embodiment.

FIG. 3 depicts an illustrative process for the user-assisted publishing of event information to social media or a personal distribution list in accordance with an embodiment.

FIG. 4 illustrates an exemplary embodiment of a system of a smart wireless device according to an aspect of the invention;

FIG. 5 illustrates an exemplary embodiment of a smart wireless device according to an aspect of the invention;

FIG. 6 illustrates an exemplary embodiment of a method for offline data downloading according to an aspect of the invention.

### DETAILED DESCRIPTION

Hereinafter, embodiments of the presently-disclosed systems and methods for performing event-based video and image reporting in the context of, inter alia, emergency and distress response scenarios are described with reference to the accompanying drawings. Like reference numerals may refer to similar or identical elements throughput the description of the figures.

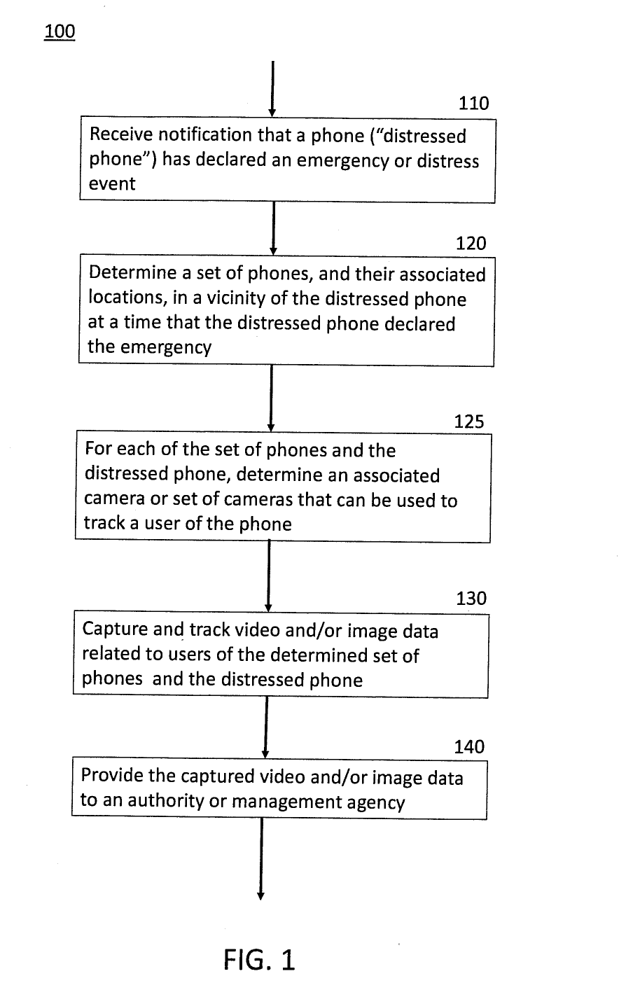

FIG. 1 depicts an illustrative process for capturing information on persons in the vicinity of a crime or distress scene in accordance with an embodiment. At 110, notification is received at a server that a particular phone (referred to hereinafter as a “distressed phone”) has declared an emergency or distress event. Declaration of the emergency or distress event may correspond to, e.g., a 911 call, a text message to any emergency or monitoring center, or any other suitable event. In addition to notification, the server receives a location of the distressed phone, e.g., in the form of GPS coordinates. In one arrangement, a mobile application is installed on a phone. The mobile application monitors calls made by the phone. When the mobile application determines that the phone has dialed 911 or otherwise initiated an emergency or distress related communication (e.g., phone call or text message), the mobile application sends a message to the server with an indication that the phone has declared an emergency or distress event. The mobile application may provide GPS coordinates of the distressed phone concurrently with the message or the location of the distressed phone may be provided in a separate message. In arrangements, operation of the server is controlled by a party that also controls some aspect of the mobile application.

At 120, the server determines a set of phones that were in a vicinity of the distressed phone at a time that the distressed phone declared an emergency. In some arrangements, the server has access to a global database of phones and their associated GPS coordinates and simply compares GPS coordinates to determine those phones in immediate vicinity of the distressed phone. In some arrangements, the server receives this information directly from the distressed phone, which captures this information using mobile-to-mobile communications (e.g., WiFi or LTE Direct communications), either by regularly pinging its environment for nearby phones or in response to detection of the emergency or distress event.

At 125, software executing on the server determines an associated camera or set of cameras for each of the set of phones determined at 120 and the distressed phone. In particular, the queries a database to determine one or more cameras in vicinity of each of these phones. The cameras listed in the database are addressable by the server. There are two types of cameras available in the database: (i) stationary cameras typically mounted on a wall (e.g., of a building) or stand-alone pole (e.g., a telephone pole, utility pole, or dedicate camera pole) and (ii) cameras mounted to other vehicles, not involved in the accident, whether parked or moving. The set of cameras is “assigned” to any given phone depend in part on the location of that phone reported at 120. In general, the same set of cameras may be assigned to multiple phones.

At 130, the server employs video and/or image tracking techniques to track each user of a phone in the set of phones determined at 120 and the distressed phone over time. Even if the user of a given mobile phone moves away from the accident scene in the moments after the distressed phone makes its initial call, the given mobile phone is tracked across the network of cameras. Any suitable tracking technology may be used. Generally, cameras may track subjects (i.e., mobile phones and their users) using video footage, still image captures, audio captures, and any combination of these features. By tracking mobile phones in the vicinity of the distressed phone and the distressed phone itself, valuable evidence may be gathered to help the police and other emergency responders allay the emergency, capture suspects, and commence legal proceedings against wrongdoers after the fact. In general, the tracking algorithms used by the software executing on the server update the set of cameras associated with a given phone over time based on updates on the phone's current location in order to ensure that relevant video and/or image data is captured for the user of the phone even as the user of the phone moves throughout the environment.

Accordingly, at 140, captured image and video data is provided to one or more authorities. Authorities may include a local police department, emergency response crew, insurance companies, other persons at the crime or distress scene, and any other interested party or parties.

Texting and Driving.

In a network of addressable cameras similar to that described above can be used to detect drivers who are preparing and/or sending text messages while operating an automobile or other motor vehicle (“texting and driving”). In an embodiment, cameras of the network are installed along roadways, e.g., on telephone and electrical polls, road signs, overpasses, and in standalone fashion on suitable hardware mounts that also include necessary processing and communications circuitry.

When a vehicle passes a camera in the network, the camera (or a set of cameras the case that each “checkpoint” includes multiple cameras) is triggered to take at least two images. The triggering may occur through weights sensors embedded under the roadway or through any other suitable means. A first image captures a license plate of the vehicle and a second image captures the driver's side area in the interior of the vehicle. By applying image processing algorithms to the first image at the site of the camera or in a central facility, it is determined whether the driver depicted in the first image is engaged in texting and driving. If it is determined that a driver is texting and driving, the first image (as evidence) and second image (i.e., the license plate image) are sent to a ticketing authority so that a ticket can be sent to the driver at his or her registered address.

In some arrangements, violators are detected purely through automated means, while in other arrangements at least some human review is involved. For example, images that return “grey area” scores may be reviewed by a human, who makes an ultimate determination as to whether the image depicts a driver who is texting while driving. In some arrangements, fees escalate for repeat offenders and points are assessed against a driver's driving score. In some arrangements, municipalities may partner with telecommunications operators to corroborate evidence (only when privacy laws clearly allow such cooperation). For example, drivers suspected of a violation based on the image processing analysis described above may have their phone records checked at the corresponding time to corroborate that a text message was indeed sent around a time that the driver's behavior was captured by the camera(s).

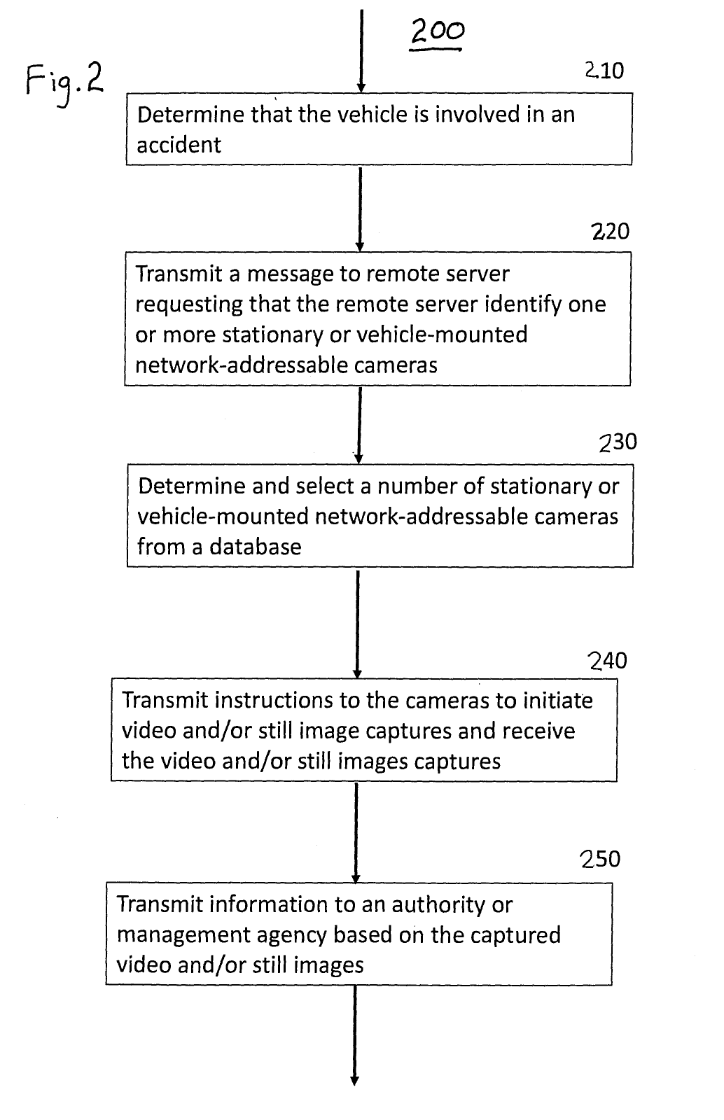

FIG. 2 depicts an illustrative process 200 for capturing vehicular accident scene information in accordance with an embodiment. The process 200 may be executed by a combination of software or hardware installed at a vehicle and a computing system remote to the vehicle and in communications with the vehicle via a network connection (e.g., a cellular, WiFi, RFID, or Bluetooth connection).

At 210, one or more systems on a vehicle determine that the vehicle is involved or likely to immediately be involved in an accident. The detection may be performed using any suitable technique including, e.g., based on motion sensors, impact sensors, glass break sensors, declaration sensors, speed sensors, and swerve sensors.

At 220, the vehicle generates and transmits a message to a server that is located remotely from the vehicle. Upon receiving the message, software running on the remote server identifies one or more stationary or vehicle-mounted and network-addressable cameras in vicinity of the vehicle. To do so, the software of the server, at 230, queries a database to determine one or more cameras in vicinity of the accident vehicle that are addressable by the server. There are two types of cameras available in the database: (i) stationary cameras typically mounted on a wall (e.g., of a building) or stand-alone pole (e.g., a telephone pole, utility pole, or dedicate camera pole) and (ii) cameras mounted to other vehicles, not involved in the accident, whether parked or moving. Also at 230, the software executing on the server selects one or more cameras from the database that are in the vicinity of the accident vehicle.

At 240, the software executing on the server generates and transmits instructions to the selected cameras to initiate video and/or still image captures to record accident scene information. In one arrangement, the server receive a location of an accident vehicle from the accident vehicle and provides this location to the cameras so that they can adjust their pan, tilt, and zoom functions to best capture footage of the accident scene. The footage is in the form of video and/or still image captures. The captured information is transmitted from the cameras back to the server.

At 250, the server transmits information to an authority or management agency based on the captured video and/or still images. Authorities may include a local police department, emergency response crew, insurance company, and individuals involved in the accident. A management agency may be a third-party service or company contracted by an authority to process data. The method 200 can be used to determine if a driver is texting and driving as discussed above.

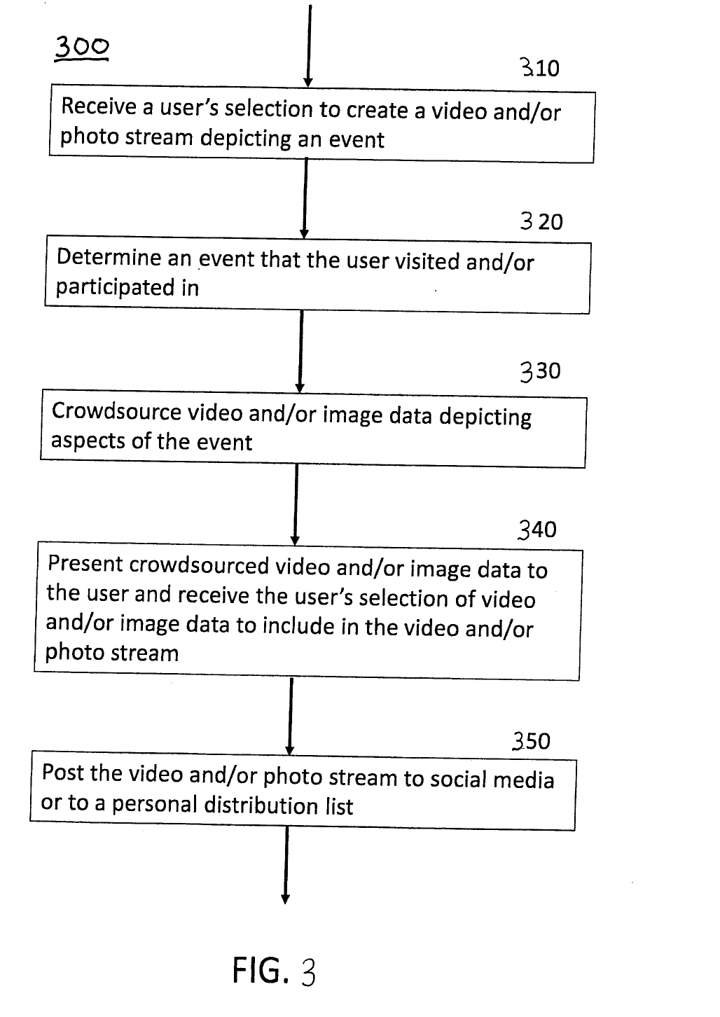

FIG. 3 depicts an illustrative process for the user-assisted publishing of event information to social media or a personal distribution list in accordance with an embodiment. In arrangements, most or all of the functionality of the process 300 is executed by a computing device. The computing device may be any of a smartphone, tablet, laptop computer, desktop computer, portable digital assistant (PDA), or any other suitable computing device. For illustrative purposes, it will be assumed in the following description that a computing device (also referred to as a “user computing device”) performs the functionality described in relation to the process 300.

At 310, the computing device receives a user's selection to create a photo or video stream depicting an event. As used herein, the term “event” is defined broadly to include any sort of small or large gathering. For example, an event may be a sporting contest (e.g., football game), music concert, political rally, national park visit, a multi-state a road trip, or an emergency or distress event. In arrangements, the user makes this selection on the computing device by selecting an “add video or photo stream” or “add event media” link from a social media software interface. In arrangements, the user makes this selection on the computing device by selecting an option on an interface of an e-mail client.

At 320, the computing device determines an event that the user visited and/or participated in. The computing device may make this decision by contacting a server and/or prompting a user. In some arrangements, the computing device makes this decision automatically. In these arrangements, the computing device may determine a location (e.g., GPS location) where it is located at a time that the user provides the user's selection at 310. The computing device then contacts a server or other database to determine, based on the location and date and time information, a likely event that the user is currently participating in. If multiple candidate events exist, the process 300 may prompt the user via a display of the computing device to select one of the candidates as the proper event.

In some arrangements, the user specifies an event title or description directly on the computing device. For example, the user might type “Giants football.” The computing device then consults a local or remote database to find known events corresponding to the user's entry. For example, the computing device may return “New York Giants v. Washington Redskins, FedEx field, 1:35 pm, Nov. 10, 2013,” as a candidate (or “recommended”) event. The user may then be able to confirm that the recommended event is indeed the event that the user visited and/or participated (i.e., the event of 320). In an emergency or distress situation a default emergency or distress event title

At 330, the computing device obtains video and/or image data depicting aspects of the event determined at 320. The computing device obtains this information from one or both of the following sources:

(1) Media Produced by the User.

At 330, the computing device may identify local and remote media produced by the user that captures scenes from the event determined at 320. Local media is media stored on the computing device itself while remote media is media stored on devices other than the computing device that are also under the operation and/or control of the user. For example, if a user visited the event with the computing device, then it is likely that the computing device contains pictures and/or video taken by the user that depicts aspects of the event. For example, at a basketball game, the user may have taken pictures of the action on the user computing device. As another example, the user may have visited the event with a different device. For example, the user may have taken pictures of a basketball game with a tablet computer but may make the selection at 310 using his cell phone. In that case, an application running on the cell phone (i.e., the user computing device) may connect to a server to access pictures and/or video from the tablet.

(2) Third-Party Sources.

Additionally or alternatively, at 330, the computing device may acquire media that captures scenes from the event determined at 320 from one or more third party sources. For example, in arrangements, the computing device may contact one or more of Twitter, Instagram, Foursquare, Associated Press media, LinkedIn, a news service, a server operated by the event manager, and a social media aggregation service. The computing device will then issue a query based on the event and receive videos and images captures from other uses that also depict the event.

In either case (1) or (2), the video and/or image data retrieved (also referred to as “crowdsourced”) at 330 may be user-centric, not-user-centric (also referred to as “non-user-centric”), or a combination of these two. In particular, user-centric video and images are those that depict the user himself or herself, while non-user-centric video and images depict the event without featuring the user. At 330, the computing device generally does not retrieve all available information available, but rather, retrieves only a sampling of available video and/or image data. The user computing device may select the sampling based on a quality (is an image in focus? Are the photographic conditions sunny or otherwise close to ideal?) and a cost to the computing device to access and retrieve the media.

At 340, the computing device presents the retrieved media to the user and receives the user's selection of items that will be posted to the photo or video stream. For example, in arrangements, the user is presented with a tiled list of videos and images. The user reviews and “taps” (on a touchscreen) those videos and images that he or she wishes to include as part of the photo stream. In some arrangements, a checkmark may appear next to or on top of each video and image that the user has tapped on.

At 350, the computing device posts the video and/or photo stream to a social media site or personal distribution list. In arrangements, the video and/or photo stream is pushed to a newsfeed on a social media website. In arrangements, the photo or video stream is sent in the form of an e-mail attachment or embedded content e-mail to an e-mail distribution list specified by the user.

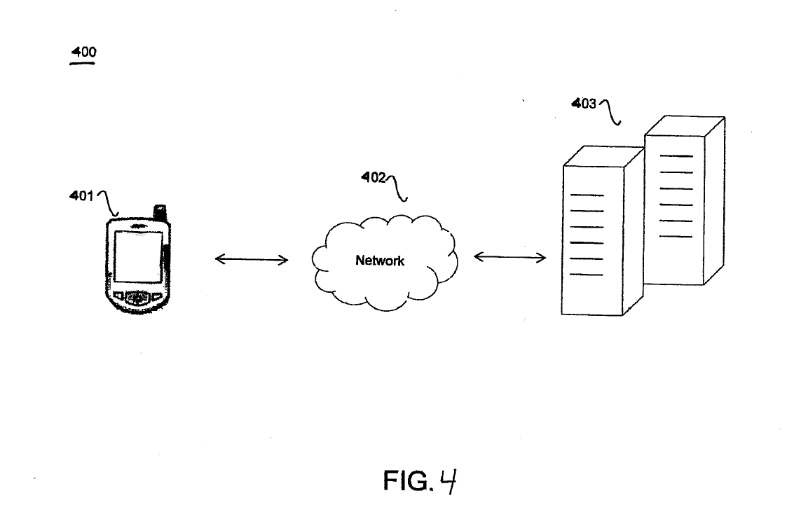

FIG. 4 illustrates an exemplary embodiment of a system of a smart wireless device according to an aspect of the invention. The system 400 may include a smart wireless device 401 that may be in communication with a database 403 over a network 402.

The smart wireless device 401 may include any of a mobile phone, a PDA, a laptop computer, a palmtop computer, a tablet, a notebook, or any other similar device that may be capable of wireless communication. The smart wireless device 401 may store information pertaining to a user of the smart wireless device 401. In an example, the information stored in the smart wireless device 401 may include wireless device data such as information about calendar activities of the user, events described in an email, information about instant messaging (IM) communications of the user and the like. The wireless device data may be stored in a memory module associated with the smart wireless device 401. In an example, the wireless device data may be used to predictively provide relevant services to the user to address the future needs of the user. The future needs of the user may be determined such as based on the user's calendar activities, events described in the email/IM and the like. For example, a calendar application on the user's smart wireless device 401 may show an appointment of the user at a location X at a time Y during a day. The information about this appointment may be stored in the memory module associated with the smart wireless device 401. The smart wireless device 401 may be configured to retrieve this information automatically from the memory module to identify the location X. Further, based on the identified location, the smart wireless device 401 may perform an action to predictably address the future needs of the user, such as at time Y, when the user moves to location X. The future needs may include such as, identifying free Wi-Fi hotspots at location X at time Y for the user to access a network, such as the Internet, when the user moves to the location X.

In an example, the smart wireless device 401 may be configured to retrieve data for processing the information about the future needs of the user from the database 403, over the network 402. The network 402 may include any of a CDMA, TDMA, GSM, WCDMA, WLAN, LAN, CR, Wi-Fi based network, or the like.

In an example, the smart wireless device 401 may communicate with the database 403 for servicing user's future needs. In an example, the database 403 is hosted by a server. In an example, the database 403 may include a globally distributed cloud based database with several levels, such as from global to local, that is to say the database 403 may be a hierarchical database. In an example, the database 403 may be accessed for offline downloading of data, whenever best feasible for the smart wireless device 401. Such data may then be stored in the smart wireless device 401 as and when required, such as for addressing a future need of the user of the smart wireless device 401.

In an example, the data stored in the database 403 may be collected for storage in a crowd sourcing manner. That is to say, a plurality of data terminals may collect relevant information all the time and report that information for storing in the database 403. This information may include such as list of free Wi-Fi hotspots at different locations, radio environment map, security parameters of base stations in an area, security information, information about reputation of CR terminals and CR base stations in a network and the like. In an example, the data terminals whose collected information is stored in the database 403 may be selected based on the reputation of the data terminals. The reputation of the data terminals may be associated with the level of security associated with the data terminals. For example, if the reputation information of a data terminal indicates that the terminal has violated security norms or has acted maliciously in the past; such data terminal's collected data may not be stored at all in the database 403.

In an example, the data terminals providing data for storing in the database 403 may be rewarded for their contribution. For example, a data terminal associated with an Internet Service Provider (ISP) may collect information about the availability of the ISP's Wi-Fi hotspots across different locations. The ISP may then provide this information to the database 403. In return, the ISP may be rewarded, such as using network credits, virtual currencies, bitcoins, and the like. The provision of rewards may be used to encourage data terminals to contribute data to the database 403. In an example, contribution of data to the database 403 and administering of rewards may be managed by a central server associated with the database 403.

In some examples, the central server may also be accessible by the smart wireless device 401, such that the smart wireless device 401 may be enabled to contribute data to the database 403. In other examples, the smart wireless device 401 may access the database 403 only for offline downloading of data. The downloaded data may then be stored in the memory module associated with the smart wireless device 401.

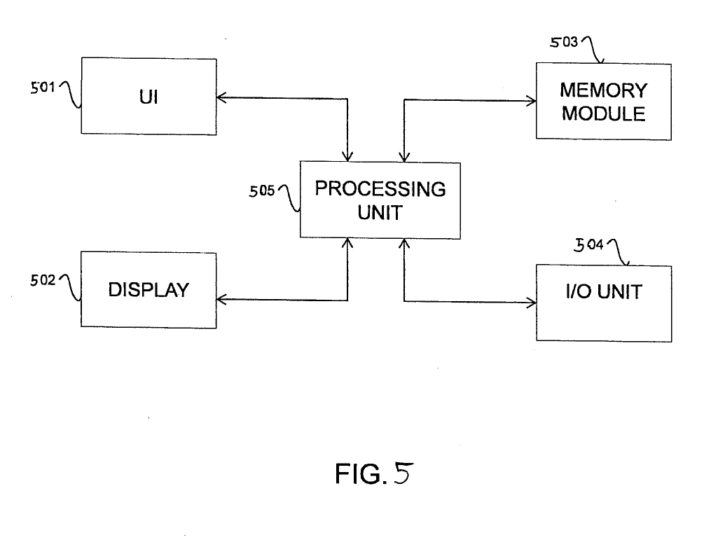

FIG. 5 illustrates an exemplary embodiment of a smart wireless device 401 according to an aspect of the invention.

The smart wireless device 401 may include a user interface (UI) 501 component, a display 502 component, a memory module 503, an Input/Output (I/O) unit 504 and a processing unit 505.

The user of the smart wireless device 401 may access the functions of the smart wireless device 401 through the UI 501 component. The UI 501 component may include any of a touchpad, a keypad, a keyboard, a mouse, a trackball, a touch screen, voice activation, or any other similar mechanism that may allow the user to access the functions of the smart wireless device 401. In an example, the UI 501 component may be used by the user to enter information related to wireless device data into the smart wireless device 401. For example, a user of a smartphone may access a calendar application using the UI 501 component of the smartphone, such as a touch screen. The user may enter details about a meeting in the calendar application. The details may include information such as a place of meeting, a time of meeting, a day and date at which the meeting is scheduled, and the like. The various details about the meeting available in the calendar application may be displayed to the user on the display 502 component of the smart wireless device 502. The display 502 component may likewise be used for displaying different forms of wireless device data to the user. The wireless device data may be retrieved from the memory module 503 of the smart wireless device 401.

The memory module 503 may be used for storing different types of wireless device data such as data related to a user's schedule, various contacts, network requirements of the user, data related to various user profiles and preferences, user's email communication data, data related to IM communications, user's social networking profile related data and the like. Thus, the memory module 503 may provide a valuable source of information about the activities and events related to the user. In an example, the data stored in the memory module 503 may be used to predict user's activities and perform offline data downloading, such as from the database 403, based on the prediction. The database 403 may be accessed using a connection between the I/O unit 504 and the database 403. The I/O unit 504 may likewise be used to connect the smart wireless device 401 to devices and/or networks external to the smart wireless device 401. In an example, the I/O unit 504 may be configured to connect the smart wireless device 401 to the database 403 over the network 402 (as illustrated in FIG. 4) for offline downloading of data.

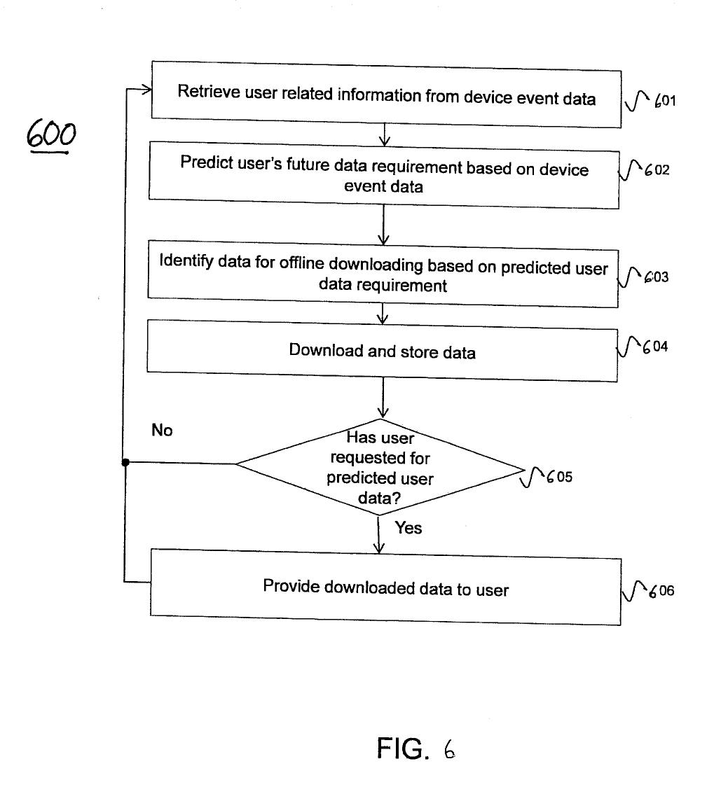

The offline downloading of data may be performed automatically by the smart wireless device 401. The downloaded data may then be used to predictably provide services to the user of the smart wireless device 401. For example, a user may receive an email invite for a concert to be held at a location L, on date D at time T. The user may access their email using the smart wireless device 401 and accept the invite. The details about the email invite, such as the location, time, day and acceptance may be stored in the memory module 503 of the smart wireless device 401. Also, the smart wireless device 401 may be equipped to monitor a location of the user. The smart wireless device 401 may be equipped with such as a GPS module that may be able to track a current location of the smart wireless device 401. In this example, the smart wireless device 401 may be used to predict that as the user moves to the concert at location L, the user may want to connect to the Internet, such as to share their experience of the concert on some social networking platforms. The prediction may lead to offline downloading of data from the database 403, by the smart wireless device, when best feasible for the smart wireless device 401. In this case, the database 403 may be a Wi-Fi or CR network information related database. The database 403 may contain information about where the Wi-Fi hotspots or CR terminals may be available in the vicinity of location L, for connecting to the internet. This data may be automatically downloaded on the smart wireless device 401 without user intervention or initiation. The decision to download the data and the prediction of need to download data may be performed by the processing unit 505, which may be configured to interact with various components of the smart wireless device 401 to process the device information. As the user enters the concert location L, the user may initiate a requirement of connection to the internet. Thus, the data about the available hotspots which was previously automatically downloaded may then be presented to the user. The information may include location of hotspots, cost associated with hotspot usage, business category such as cafeteria, clothing, swimming hall, private home and the like), a start page commercial for a hotspot service provider, hours of operation, usability of hotspot outside opening hours, network name and password if applicable and the like. Thus, the user may save on a lot of time and cost by using the already offline downloaded information and quickly connected to a suitable hotspot (or CR network). The process of offline data downloading may be explained in the method of FIG. 6.

FIG. 6 illustrates an exemplary embodiment of a method for offline data downloading according to an aspect of the invention.

The method 600 includes, at 601, retrieving user related information from the data stored in the smart wireless device 401. The data stored in the smart wireless device 401 may relate to some events, such as a calendar appointment, a schedule, a meeting, and the like of the user. Based on the data retrieved about the event, the user's future data requirement may be predicted at 602. The future data requirement may be related to such as network preference, device capability requirement, user preference at a specific location, and the like. Once the future data requirement is predicted, at 603, a suitable data source may be accessed for offline downloading the data based on the predicted data requirement. Further, at 604, the data may be downloaded and stored in the smart wireless device 401. At 605, it may be determined whether the user has requested for predicted data. If yes, then at 606, the downloaded data is provided to the user, such as using the display 502 component of the smart wireless device 401. Otherwise the step 601 of retrieving user related information from device event data is continued. Further, even after the downloaded data is provided to the user at 606, the smart wireless device 401 may continue to retrieving user related information from device event data for future requests.

The method of FIG. 6 may be used to provide a cost and speed efficient Internet connectivity solution to a user of the smart wireless device 401.

Embodiments of the present invention may be implemented in software, hardware, application logic, or a combination of software, hardware, and application logic. The software, application logic, and/or hardware may reside on mobile computer equipment, fixed equipment, or servers that may not always be owned or operated by a single entity.

If desired, part of the software, application logic and/or hardware may reside on multiple servers and equipment in charge of different processes.

In an example embodiment, the application logic, software or an instruction set is maintained on any one of various conventional computer-readable media. In the context of this application, a “computer-readable medium” may be any media or means that can contain, store, communicate, propagate, or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a fixed or mobile computer.

If desired, the different functions discussed herein may be performed in a different order and/or concurrently with each other. Furthermore, if desired, one or more of the above-described functions may be optional or can be combined. As technology advances, new equipment, and techniques can be viable substitutes of the equipment and techniques that have been described in this application.

Although embodiments have been described in detail with reference to the accompanying drawings for the purpose of illustration and description, it is to be understood that the inventive processes and apparatus are not to be constructed as limited thereby. It will be apparent to those of ordinary skill in the art that various modifications to the foregoing embodiments may be made without departing from the scope of the invention.

1. A method of collecting information related to a crime or distress scene, the method comprising:
receiving an indication that a phone has declared an emergency or distress event and a location of the phone, wherein the phone is a distressed phone;
determining an additional set of phones, and their associated geographic locations, in vicinity of the distressed phone at a time that the distressed phone declared the emergency or distress event;
for each of the additional set of phones and the distressed phone, determining a number of cameras capable of tracking the distressed phone; and
for a phone from the additional set of phones and the distressed phone, capturing video or image data related to a user of the phone using at least one of the determined number of cameras capable of tracking that phone.

2. The method of claim 1, wherein determining the additional set of phones, and their associated geographic locations, comprises receiving information identifying the additional set of phones from the distressed phone.

3. The method of claim 1, wherein capturing video or image data related to a user of the phone comprises:
capturing video or image data of the user of phone using a first of the at least one of the determined number of cameras capable of tracking that phone during a first time interval but not during a second time interval; and
capturing video or image data of the user of the phone using a second of the at least one of the determine number of cameras capable of tracking that phone during a second time interval but not during a first time interval.

4. A method for reporting accident scene information, the method comprising:
receiving an indication that an accident occurred at a location;
searching a database to identify one or more addressable cameras located in vicinity of the location;
instructing the identified one or more addressable cameras to record video or image data of an accident scene in vicinity of the location; and
providing the recorded video or image data to an authority.

5. The method of claim 4, wherein the instructing causes at least one of the one or more addressable cameras to adjust a pan, tilt, or zoom setting.

6. The method of claim 4, wherein the one or more addressable cameras includes at least one camera mounted on a stationary vehicle that is not a party to the accident.

7. The method of claim 4, wherein the one or more addressable cameras includes at least one camera mounted on a moving vehicle that is not a party to the accident.

8. A method for generating a video or photo stream, the method comprising:
determining an event that a user visited or participated in;
identifying video or image data depicting aspects of the event;
presenting the identified video or image data to the user;
receiving the user's selection of at least some of the identified video or image data; and
associating the user's selection of at least some of the identified video or image data with at least one of a social media website and an e-mail distribution list.

9. The method of claim 8, wherein the identified video or image data includes at least one user-centric type of media and at least one non-user centric type of media.

10. The method of claim 8, wherein associating the user's selection of at least some of the identified video or image data with at least one of a social media website and an e-mail distribution list comprises posting the user's selection of at least some of the identified video or image data to a news feed of a social media website.

11. The method of claim 8, wherein associating the user's selection of at least some of the identified video or image data with at least one of a social media website and an e-mail distribution list comprises causing transmission of an e-mail containing the user's selection of at least some of the identified video or image data to addresses of an e-mail distribution list.

12. The method of claim 8, wherein determining an event that the user visited or participated in comprises:
presenting a candidate event to the user; and
receiving the user's confirmation of the candidate event.

13. A method for determining user data comprising:
retrieving information related to a user from device event data;
predicting a future data requirement of the user based the device event data;
identifying data for offline downloading based on the predicted future data requirement; and
downloading the identified data.

14. The method of claim 13, further comprising:
determining whether the user has requested data associated with the predicted future data requirement; and
providing the identified data to the user in response to determining that the user has requested data associated with the predicted future data requirement.

15. The method of claim 13, wherein the device event data comprises calendar appointment information.

16. The method of claim 13, wherein the future data requirement is associated with a device capability requirement.

17. The method of claim 13, further comprising predicting an additional future data requirement of the user after the downloading of the identified data.
